(19) United States
(12) Patent Application Publication
(10) Pub. No.: US 2026/0168931 A1
(43) Pub. Date: Jun. 18, 2026

(54) PROBE FOR LIQUID ANALYSIS

(71) Applicant: Watergenics GmbH, BERLIN (DE)

(72) Inventor: Liviu MANTESCU, BERLIN (DE)

(21) Appl. No.: 19/121,676

(22) PCT Filed: Oct. 27, 2023
(86) PCT No.: PCT/IB2023/060846

§ 371 Date: Apr. 16, 2025

(30) Foreign Application Priority Data
Nov. 4, 2022 (DE) 10 2022 129 251.7

(51) Int. Cl. G01N 21/65; G01J 3/02; G01N 21/59; G01N 35/10

(52) U.S. Cl. CPC G01N 21/65; G01J 3/02; G01N 21/59; G01N 21/658; G01N 35/1016

(57) ABSTRACT

A probe for ongoing liquid analysis, having at least one detector for measuring the spectral properties of the liquid, and a liquid-tight housing for receiving the at least one detector, wherein at least one window is arranged in a wall of the liquid-tight housing, through which the at least one detector detects spectral properties of the liquid, wherein the liquid-tight housing is connected to a flow channel through which the liquid flows. The flow channel is wound.

### CROSS-REFERENCES TO RELATED APPLICATIONS

This application is a national phase of International Patent Application No. PCT/IB 2023/060846, filed on Oct. 27, 2023, which claims the benefit of German Patent Application No. 10 2022 129 251.7, filed on Nov. 4, 2022, the entire disclosures of which are incorporated herein by way of reference.

### FIELD OF THE INVENTION

The invention relates to a probe for continuous liquid analysis, comprising at least one detector for measuring the spectral properties of the liquid to be analyzed and a liquid-tight housing for accommodating the at least one detector, wherein the at least one detector is housed in the liquid-tight housing, and wherein at least one window is arranged in the wall of the liquid-tight housing, through which the at least one detector detects the spectral properties of the liquid to be analyzed, wherein the liquid-tight housing is connected to a flow channel through which the liquid to be analyzed flows, and wherein the at least one window is directed into the flow channel.

### BACKGROUND OF THE INVENTION

For continuous liquid analysis, also known as online monitoring, flow-through cuvettes are known, through which the liquid to be examined spectroscopically flows. Such flow-through cuvettes are used in laboratories or pilot plants to analyze, for example, the composition of a liquid or the concentration of a specific substance in continuous chemical processes. Flow-through cuvettes are also used in wastewater treatment to continuously monitor both untreated wastewater and purified water.

A specific case is the continuous monitoring of mine water. Mine water accumulates in abandoned mines, and pumps are used to maintain it at a constant level. If the level drops, groundwater may flow into the gradually emptying mine. If the level rises too high, mine water may seep into the groundwater, introducing heavy metals from deeper rock layers. Maintaining the mine water level is a perpetual task. To ensure that groundwater does not mix with mine water, both the mine water and the surrounding groundwater are continuously analyzed. Mine water can release chlorides, heavy metals, nitrates, and pollutants from hazardous waste previously disposed of in mines to the surface. Not all of these contaminants can be continuously analyzed using spectroscopic methods, or they are only detectable with highly sensitive spectroscopic techniques, such as Raman spectroscopy. The sensitivity of the measuring instruments and the extremely harsh conditions for monitoring mine water present a significant challenge.

For online monitoring of mine water using Raman spectroscopy, it is necessary to direct a laser beam into the mine water to be monitored and measure the Raman emission that is scattered back due to the Raman effect. The excitation laser light and the Raman emission differ in intensity by several orders of magnitude. Since the Raman emission has a different wavelength than the excitation wavelength, monochromatic laser scattering caused by particles can be separated from the Raman emission using diffraction gratings in the Raman spectrometer. However, stray light-such as stray sunlight that falls within the Raman emission wavelength range-cannot be separated from the actual Raman emission. Therefore, it is essential that the mine water flowing through a Raman spectrometer is protected from external light.

Another problem is that a window separating the mine water from the Raman spectrometer quickly becomes covered with algae or yellowed due to precipitates from the water, eventually becoming completely opaque. Deposits may include iron oxide or other heavy metal oxides, lime deposits, and bacterial growth. The apparatus must therefore withstand the harsh conditions of a mine, guide the mine water past a window for a spectrometer while being protected from external light, and allow the window to be cleaned without damage and without requiring manual cleaning. The number of probes used in a mining area is too high to manually clean each deployed probe or Raman spectrometer within the time it takes for biofouling or deposits to form.

Very similar conditions concerning biofouling and deposits are found in wastewater from agricultural operations, such as manure, wastewater from fermentation pits in biogas plants, as well as in water management, industrial and municipal wastewater treatment plants, and water circulation systems of industrial cooling towers, to name just a few examples. Such continuously monitored liquids share the characteristic of causing biofouling, bacterial growth, or the deposition of dissolved substances. These liquids are referred to in this application as substance-laden liquids.

The problem of the invention is therefore to provide a probe for continuous liquid analysis that withstands the harsh conditions of substance-laden liquids, guides the substance-laden liquid past a spectrometer while being protected from external light, and is easy to clean.

### SUMMARY OF THE INVENTION

This problem may be solved by a probe having the features of one or more embodiments described herein.

According to the various embodiments of the invention, it is provided that the flow channel is wound. Surprisingly, it has been found that a wound shape of the flow channel, on the one hand, ensures that laser light immersed in the liquid, for example, is sufficiently re-emitted through Raman emission. On the other hand, a window facing the flow channel is protected from external light, particularly sunlight. The flow along the winding creates strong turbulence in the liquid, which slows down biofouling or the deposition of substances present in the substance-laden liquid.

The probe designed in this way is suitable for various types of spectroscopic investigations. This includes all types of optical spectroscopy, such as UV/VIS spectroscopy, IR/NIR spectroscopy, light scattering measurements, polarimetry, and refractive index measurements. The probe with the wound flow channel is particularly suitable for spectroscopic online monitoring using Raman spectroscopy. To this end, an embodiment of the probe according to the invention provides that the detector is a Raman spectrometer and that a laser beam shines into the liquid to be analyzed through at least one window.

A particularly suitable shape for the wound flow channel is a helical form. In addition to the helical form, other three-dimensionally wound shapes of the flow channel are possible. The exact shape of the helical flow channel can be designed in various ways.

It is possible for the helical shape of the flow channel to have a varying torsion along its course, wherein the torsion continuously varies. The term “torsion” is to be understood here in the mathematical-differential geometric sense. The torsion of a helix describes its curvature and torsion. If the torsion varies, the shape is no longer a uniform helix, but rather the curvature and torsion of the helix vary. By varying the curvature, a uniform parabolic velocity profile is formed within the lumen of the flow channel. This uniformity prevents cavitation effects that would otherwise gradually erode the surface of the flow channel and a window directed into the flow channel. It also slows down biofouling and the deposition of dissolved substances.

It is possible for the helical shape of the flow channel to have a constant helix diameter while the number of turns along its axis varies. In this embodiment, the liquid flowing through the flow channel undergoes an increasing number of rotations per unit time along the axis of the helix, thereby causing radial acceleration of the liquid.

In another advantageous embodiment of the flow channel, the helical shape of the flow channel has both a varying number of turns along its axis and a varying helix diameter. This design enhances the effect of radial acceleration of the liquid flowing through the flow channel. The acceleration effect strongly counteracts biofouling and the deposition of dissolved substances. In yet another embodiment of the flow channel, the helical shape has a constant number of turns along its axis while the helix diameter varies, further increasing radial acceleration during inflow.

In a particular embodiment of the invention, both the helix diameter and torsion may vary. This means that the helical shape of the flow channel may have both a varying number of turns along its axis and a varying helix diameter.

To reliably exclude external light, the torsion of the flow channel should be at least half a turn. Thus, the helical shape of the flow channel may range from 0.5 turns (180°) to six turns (1,080°). It is possible to design more turns, but excessive turns result in high pressure losses, which hinder uniform flow through the flow channel, especially at low inflow pressures of 1 mBar to 50 mBar.

For use in mine water applications, the diameter of the flow channel should not be too small to avoid excessive pressure loss and to allow for cleaning. It has been found advantageous if the flow channel has a ratio of diameter to length between 0.5% and 5%, and the diameter of the flow channel is between 2 mm and 2 cm. These values have been found optimal for the viscosity of mine water to prevent biofouling and deposits while ensuring easy flow.

To clean the flow channel, a nozzle is provided, which opens into the flow channel, allowing cleaning fluid to be introduced into the flow channel. This allows the probe to be connected to a clean water hose, which regularly flushes the flow channel with clean water or a cleaning solution through the nozzle. A remotely controlled valve can trigger the cleaning process.

### BRIEF DESCRIPTION OF THE DRAWINGS

The invention is explained in greater detail with reference to the following figures. These show:

FIG. 1: A sketch of an open probe in a perspective view.

FIG. 2: The open probe from FIG. 1 in a partially transparent view.

FIG. 3: The open probe from FIG. 1 in a top view.

FIG. 4: The open probe from FIG. 1 in a partially transparent view from another perspective.

FIG. 5A: A first illustration of a flow channel in the probe.

FIG. 5B: A second illustration of a flow channel in the probe.

FIG. 5C: A third illustration of a flow channel in the probe.

FIG. 5D: A fourth illustration of a flow channel in the probe.

### DETAILED DESCRIPTION OF THE PREFERRED EMBODIMENTS

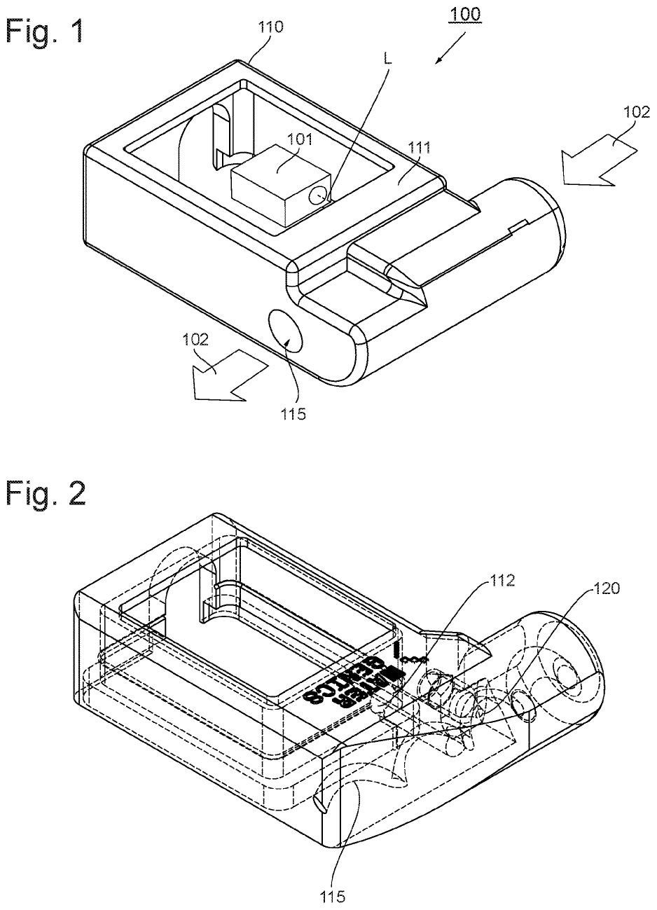

In FIG. 1, a sketch of an open probe 100 in a perspective view is shown. The probe 100 in this embodiment consists of a liquid-tight housing 110 that accommodates the detector 101, wherein the detector 101 is configured to measure the spectral properties of a liquid 102 to be analyzed. In the wall 111 of the liquid-tight housing 110, there is a window 112 (FIG. 2) through which the detector 101 detects the spectral properties of the liquid 102. The liquid 102 to be analyzed flows through a flow channel 115 arranged within the housing, with the aforementioned window 112 being oriented toward the liquid 102 for detection by the detector 101.

The embodiment of the probe 100 shown here features exactly one detector 101. This detector is a Raman spectrometer, which directs a laser beam L through the window 112 into the liquid 102 to be analyzed and measures the spectrum of the resulting Raman scattering. However, it is also possible for more than one detector to be present in the probe 100. These detectors may share a window 112 or each have a dedicated window assigned to them.

The embodiment of the probe 100 shown here is designed to be submerged in mine water for extended periods to monitor mine water quality. The problem addressed by this probe is to guide the liquid 102 past the window 112 in such a way that stray external light, such as sunlight, does not reach the detector 101, while also preventing stray laser light from the laser beam L from escaping outward.

To shield against stray light, the invention provides that the flow channel 115 is wound. Due to the wound shape of the flow channel 115, the laser beam L is effectively trapped in a radiation trap, and external light, such as sunlight, cannot propagate through the windings and reach the detector.

Since the probe 100 is intended to remain submerged in the liquid 102 (mine water) for extended periods, a nozzle 120 is provided, through which a cleaning fluid can be introduced into the flow channel 115. The cleaning fluid may be clear water injected under high pressure, but it is also possible to use a special cleaning fluid containing detergents or chemically active substances that dissolve contaminants, such as highly oxidizing additives like hypochlorites or peroxides.

In FIG. 2, the open probe from FIG. 1 is shown in a partially transparent view. In this view, the window 112 in the wall 111 of the housing 110 is visible, leading from the interior of the probe 100 to the wound flow channel 115. In addition to the window 112, the nozzle 120 is also visible, through which cleaning fluid can enter the flow channel 115. The cleaning fluid enters via the nozzle 120 and exits through openings where the liquid to be analyzed flows into and out of the probe.

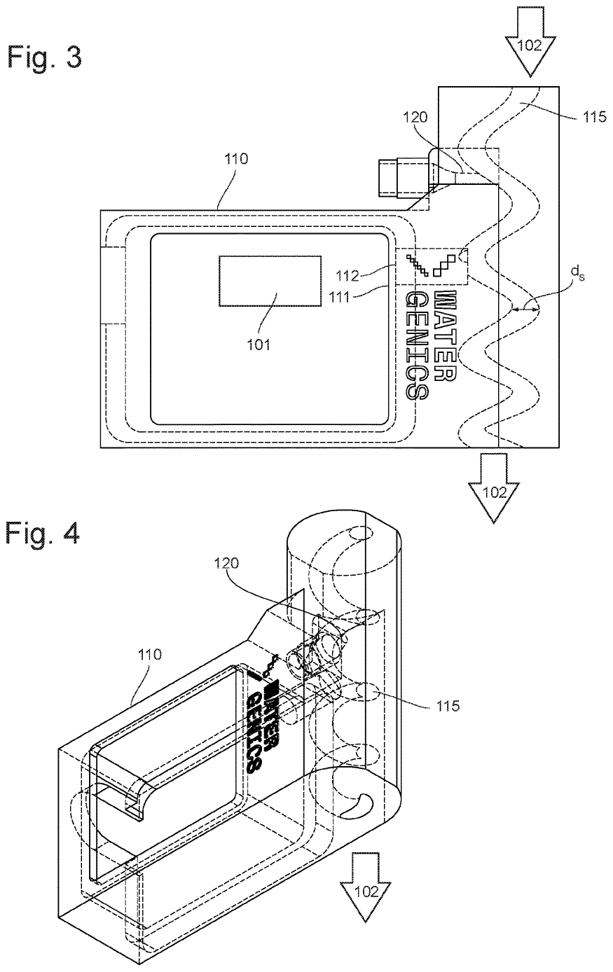

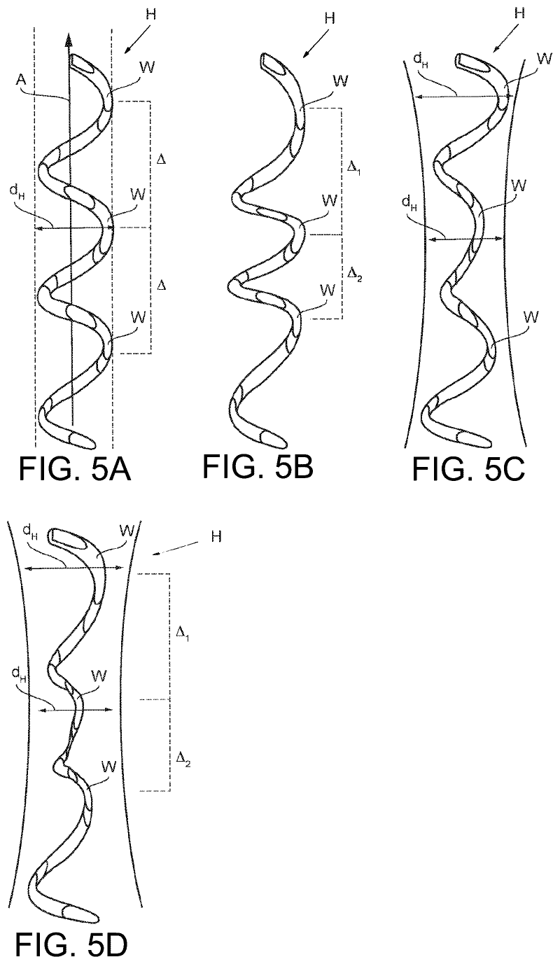

To illustrate the wound nature of the flow channel, FIG. 3 presents the open probe from FIG. 1 in a top view. This transparent two-dimensional representation shows the flow channel 115 as appearing to meander only in two dimensions. However, in reality, the channel is helically shaped, forming individual windings W (FIG. 5).

The helical nature of the flow channel 115 is clearly evident in FIG. 4. FIG. 4 shows the open probe from FIG. 1 in a partially transparent view from another perspective, allowing the individual windings W to be traced along the three-dimensional path of the flow channel 115. The nozzle 120 is positioned adjacent to the section of the probe 100 housing the detector 101. A cleaning hose can be connected to the nozzle 120.

In FIGS. 5A to 5D, different fundamental shapes of the flow channel 115 within the probe 100 are illustrated. FIG. 5A shows a uniform helical flow channel. In this design, the winding pitch Δ between two windings W remains constant. The winding pitch Δ is defined as the path length along the axis A over which the winding W completes a full 360° turn. In this configuration, the diameter d_{H} of the helix or the individual windings W remains constant, and the helix H exhibits a constant torsion in the mathematical-differential geometric sense. FIG. 5B shows another possible configuration of a helical flow channel H. In this case, the diameter d_{H} of the helix or the individual windings W remains constant, but the winding pitch A continuously varies, such that a first winding pitch Δ₁ between two windings W is greater than a second winding pitch Δ₂ between another pair of windings W. The change in winding pitch of the helix H occurs continuously in the mathematical-differential geometric sense and does not exhibit abrupt changes. FIG. 5C shows another possible configuration of a helical flow channel H. Here, the diameter d_{H} of the helix or the successive windings is not constant, but instead passes through a minimum. However, the winding pitch Δ remains constant, meaning that the distance between successive windings W remains unchanged. The variation in the diameter d_{H} of the helix or successive windings occurs continuously and does not exhibit abrupt transitions. FIG. 5D illustrates yet another possible configuration of a helical flow channel H. In this case, neither the diameter d_{H} of the helix or the individual windings W is constant, nor is the winding pitch Δ uniform. Instead, a first winding pitch Δ₁ between two windings W is greater than a second winding pitch Δ₂ between another pair of windings W.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE LIST

100 Probe
101 Detector
102 Liquid
110 Housing
111 Wall
112 Window
115 Flow channel
120 Nozzle
A Axis
d_{H} diameter
(helix)
d_{S} diameter
(flow channel)
Δ Winding pitch
Δ₁ Winding pitch
Δ₂ Winding pitch
L Laser beam
W Winding

1-10. (canceled)

11. A probe for continuous liquid analysis, the probe comprising:
at least one detector for measuring spectral properties of a liquid to be analyzed; and
a liquid-tight housing for accommodating the at least one detector,
wherein the at least one detector is housed in the liquid-tight housing,
wherein at least one window is arranged in a wall of the liquid-tight housing, through which the at least one detector is configured to detect the spectral properties of the liquid,
wherein the liquid-tight housing is connected to a flow channel, through which the liquid is configured to flow,
wherein the at least one window is directed into the flow channel,
wherein the flow channel is wound and comprises a helical shape forming a helix, and
wherein the helical shape of the flow channel comprises a varying number of turns along an axis of the helix and a varying diameter.

12. The probe according to claim 11, wherein the at least one detector is a Raman spectrometer, and
wherein a laser beam is configured to shine into the liquid through the at least one window.

13. The probe according to claim 11, wherein the helical shape of the flow channel comprises a varying winding along a length of the flow channel, wherein the varying winding continuously varies.

14. The probe according to claim 11, wherein the helical shape of the flow channel comprises a constant diameter of the helix, with a varying number of turns along the axis.

15. The probe according to claim 11, wherein the helical shape of the flow channel comprises a constant number of turns along the axis with a varying diameter of the helix.

16. The probe according to claim 11, wherein the helical shape of the flow channel comprises between 0.5 turns (180°) and six turns (1,080°).

17. The probe according to claim 11, wherein the flow channel has a ratio of a diameter of the flow channel to a length between 0.5% and 5%, and wherein a diameter of the flow channel is between 2 mm and 2 cm.

18. The probe according to claim 11, wherein a nozzle opens into the flow channel, through which a cleaning liquid is configured to flow into the flow channel.
